(19) United States
(12) Patent Application Publication
(10) Pub. No.: US 2012/0285341 A1
(43) Pub. Date: Nov. 15, 2012

(54) Variable Ink Metering and Delivery System for Flexographic Printing

(76) Inventor: Ralph E. Dedman, Coon Rapids, MN (US)

(21) Appl. No.: 13/561,342

(22) Filed: Jul. 30, 2012

Related U.S. Application Data
(63) Continuation-in-part of application No. 12/492,897, filed on Jun. 26, 2009, now abandoned.

(51) Int. Cl. B41F 31/18

(52) U.S. Cl. 101/350.1; 101/483

(57) ABSTRACT

Flexographic printing using a processor to apply a control value to an ink pumping and control system responsive to the control value, where the control value sets an operating mode of the ink pumping and control system, where the ink pumping and control system includes a stepper motor coupled to a peristaltic pump. Ink is pumped through the rotary coupling into a rotating diffusion cylinder and metered through a plurality of passages so as to contact a permeable membrane covering the diffusion cylinder. A dual blade assembly cleans the permeable membrane and ink passing through the permeable membrane is metered onto a printing plate or printing sleeve.

### CROSS-REFERENCE TO RELATED APPLICATION

This application is a continuation-in-part of co-pending U.S. patent application Ser. No. 12/492,897, filed Jun. 26, 2009, entitled “Variable Ink Metering and Delivery System for Flexographic Printing,” to the same inventor herein and claims the priority benefit of that filing date. application Ser. No. 12/492,897 is incorporated by reference.

### TECHNICAL FIELD

The present invention relates to flexographic printing in general, and, more particularly, to a variable ink metering and delivery flexographic printing system, in which a diffusion mechanism is metered to allow controlled delivery of ink to a printed output, such as a flexographic printing plate or printing sleeve.

### BACKGROUND

The flexographic printing process is heavily used by the food packaging industry for their package printing needs. Flexography, which evolved from the letter press, uses a flexible relief printing plate or printing sleeve along with an anilox roll in its printing process. The image of what is to be printed is etched into the printing plate or printing sleeve by a computer-guided laser, a molding process or through using a light-sensitive polymer. The printing plates or sleeves are typically either rubber or polymer. The flexographic printing process currently utilizes an ink metering and delivery system which consists of an ink reservoir, an anilox roll, and a “wiping” system (typically a doctor blade or a metering roll) to control excess ink delivery. In order to print an image, ink is transferred from an ink roll or reservoir to the anilox roll and from the anilox roll onto a printing plate or printing sleeve which then reproduces the image.

A flexographic printing sleeve (herein called “printing sleeve”) can be used as a carrier roll for flat, imaged printing plates mounted on the surface. One example of a carrier roll sleeve is disclosed in U.S. Pat. No. 6,619,200, to Cacchi, issued Sep. 16, 2003 and entitled “METHOD FOR PRODUCING FLEXOGRAPHIC PRINTING SLEEVES, AND THE SLEEVE OBTAINED,” which is incorporated by reference. In other applications, an image for printing is directly engraved on the flexographic printing sleeve surface, eliminating the need for a flexographic printing plate. In some examples, printing sleeves are made from a continuous pre-manufactured sleeve with a seamless layer of photopolymer topped by a laser ablation mask coating, ready for imaging, exposure, and processing. Other types of printing sleeves are also available, made, for example, by mounting individual pieces of photopolymer on a base tube with sticky-back tape.

Referring now to FIG. 1, an example of a flexographic printing setup as used in the prior art is shown. The setup may include a metering doctor blade 50 which bears on an anilox roll 52. The anilox roll 52 rotates while metering ink onto an oppositely rotating printing plate cylinder 54. The printing plate cylinder 54 impresses a printed output onto a substrate or web 58. An impression cylinder 56 provides resistance for the printing plate cylinder 54. In some applications, as indicated here, the metering doctor blade may be enclosed in a blade assembly and include input and output ports for metering ink.

Anilox rolls are hard cylinders with steel or aluminum cores which are coated with an industrial ceramic and laser-engraved with many small dimples or cells. The number and density of cells on a given roll varies according to the amount of resolution and detail required. An engraved anilox roll is expensive, delicate and susceptible to damage by mishandling. Care must be taken not to scratch or bump the roll or otherwise degrade the cells, as when wiping with a doctor blade. Unfortunately, while currently ubiquitous in flexography, doctor blades present substantial hazards. As currently used the blades are dangerously sharp, thus adversely affecting workplace safety. Further, doctor blades themselves can be a cause of damage to the delicate cell structures engraved on anilox rolls. Therefore, there is an unanswered need in the art to eliminate wiping with doctor blades, while maintaining an acceptable level of printing quality.

Besides the hazards associated with doctor blades and the use of expensive anilox rolls, flexographic printing systems exhibit a number of additional drawbacks. For example, there is a need for an improved system that adjusts the supply of the applied ink film during operation without stopping the process to replace or adjust major components. There is also a need for more consistent, and repeatable ink delivery that overcomes problem factors that affect anilox rolls like surface wear, cell plugging, damage during use and handling, and difficulty in cleaning. Further, the process of producing the ceramic anilox roll is inconsistent and difficult to control, making the production of similar rolls with the same ink delivery characteristics virtually impossible.

These factors, along with other variables, prevent the flexographic printing process from producing a level of predictable, repeatable print quality which is competitive with other common print processes (e.g. offset/litho, gravure, and digital). Additionally, since key components are prone to frequent wear, damage, and loss of available volume, the cost to clean, repair, or replace these components detrimentally impacts efficient, cost-effective print production. The present invention as disclosed herein provides new and novel solutions to the aforesaid problems by providing a system that eliminates both the need for anilox rolls and doctor blades.

### SUMMARY OF THE DISCLOSURE

A system and method for flexographic printing is disclosed using a processor to apply a control value to an ink pumping and control system responsive to the control value, where the control value sets an operating mode of the ink pumping and control system, where the ink pumping and control system includes a stepper motor coupled to a peristaltic pump. Ink is pumped through the rotary coupling into a rotating diffusion cylinder and metered through a plurality of passages so as to contact a permeable membrane covering the diffusion cylinder. A dual blade assembly cleans the permeable membrane and ink passing through the permeable membrane is metered onto a printing plate or printing sleeve.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 schematically shows a block diagram of one example of a known flexographic printing system.

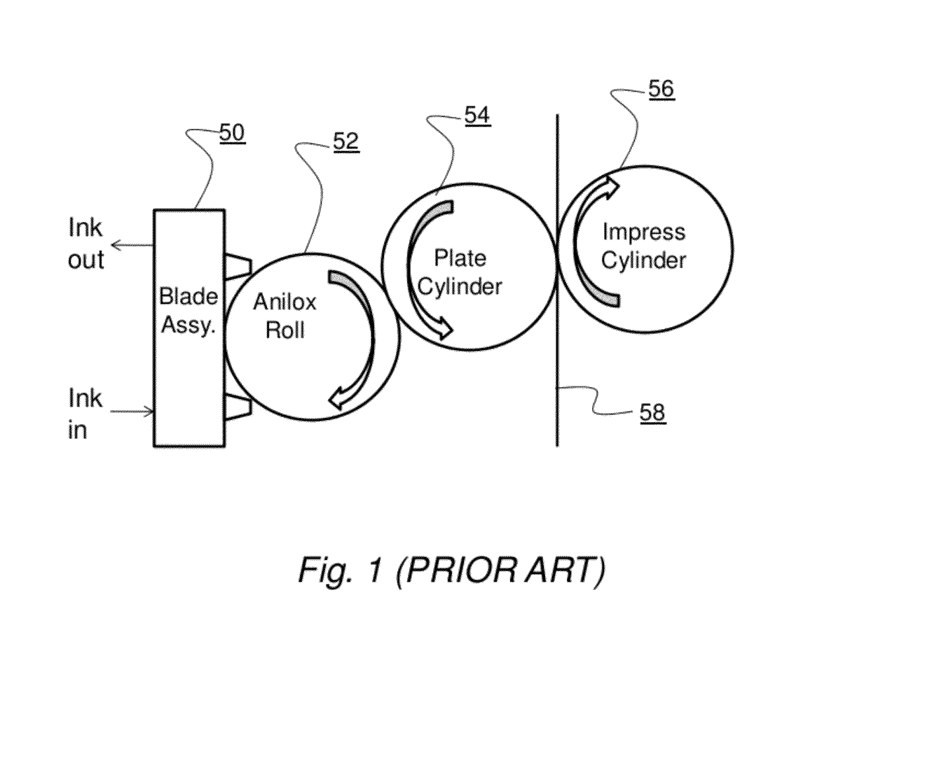

FIG. 2 schematically shows a block diagram of one example of a flexographic printing system employing two-stage ink metering.

FIG. 3 schematically shows a more detailed example of a diffusion cylinder as employed in a flexographic printing system employing two-stage ink metering.

FIG. 4 schematically shows an exploded view of a diffusion cylinder with a permeable membrane tube as employed in a flexographic printing system in accordance with the disclosure herein.

FIG. 5 schematically shows a more detailed example of a pumping and control system as employed in a flexographic printing system in accordance with the disclosure herein.

FIG. 6 schematically shows a flow diagram of a flexographic printing system employing two-stage ink metering.

FIG. 7 schematically shows an alternate example of a pumping and control system employing a stepper motor as employed in a flexographic printing system in accordance with the disclosure herein.

FIG. 8 schematically shows an example of a doctor blade assembly.

FIG. 8A shows a more detailed view of the doctor blade assembly.

FIG. 9 schematically shows an exploded view of a permeable membrane tube and end caps as employed in a flexographic printing system in accordance with the disclosure herein.

FIG. 10 schematically shows a perspective view of a permeable membrane tube assembly with axle as employed in a flexographic printing system in accordance with the disclosure herein.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several embodiments and systems for flexographic printing processes. Several features of methods and systems in accordance with example embodiments are set forth and described in the Figures. It will be appreciated that methods and systems in accordance with other example embodiments can include additional procedures or features different than those shown in the Figures. Example embodiments are described herein with respect to different control arrangements. However, it will be understood that these examples are for the purpose of illustrating the principles, and that the invention is not so limited. Additionally, methods and systems in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or various combinations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

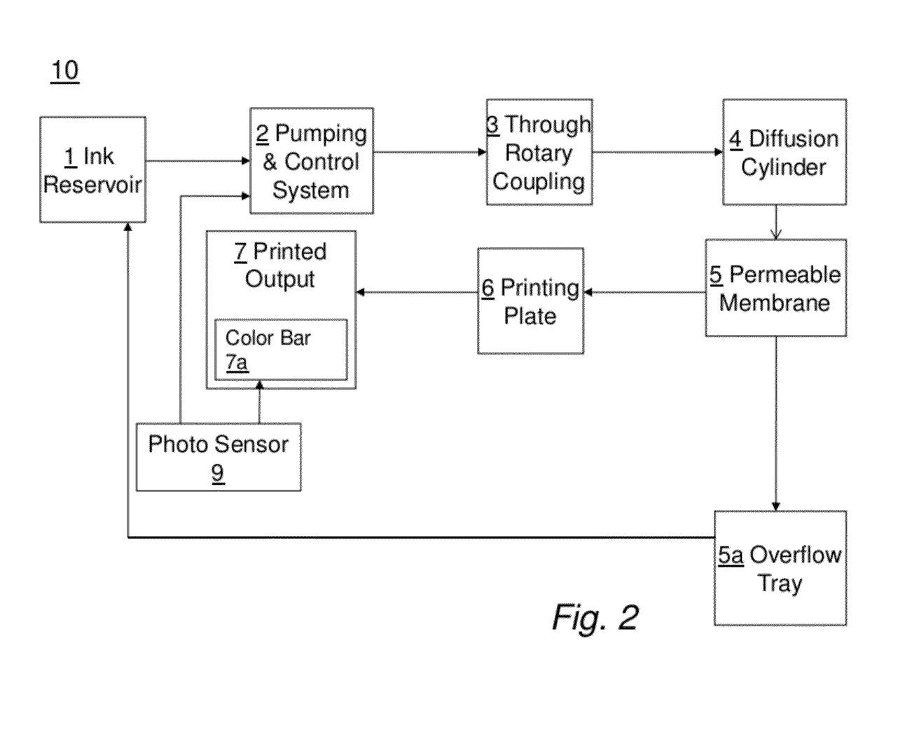

Referring now to FIG. 2, a block diagram of one example of a flexographic printing system is schematically shown. A flexographic printing system 10 includes an ink reservoir 1 coupled to a pumping and control system 2 which is, in turn, coupled to through rotary coupling 3, which is, in turn, coupled to diffusion cylinder 4. The diffusion cylinder 4 is covered by permeable membrane 5 to form a diffusion cylinder/tube assembly. Ink passes through the printing surface of permeable membrane 5 to a printed output. Excess ink from the permeable membrane 5 may advantageously be captured by an overflow tray 5a. The overflow collection tray 5a is typically mounted underneath the diffusion cylinder/tube assembly. The overflow collection tray 5a may be equipped with wiping surfaces along the elongated edges and the rear lip, in order to wipe away any unapplied ink from the surface as the cylinder turns. The overflow tray 5a may also advantageously be coupled to the ink reservoir 1 for the purpose of reticulating unused ink. For example, a drain hose may be attached between the overflow collection tray 5a and the ink reservoir 1 to return excess ink to the ink reservoir by gravity feed.

The printed output 7 may advantageously include quality control indicia 7a such as a color bar or equivalent printed pattern on the printed output. A photo sensor 9 may be advantageously located to sense the color bar properties as a control mechanism.

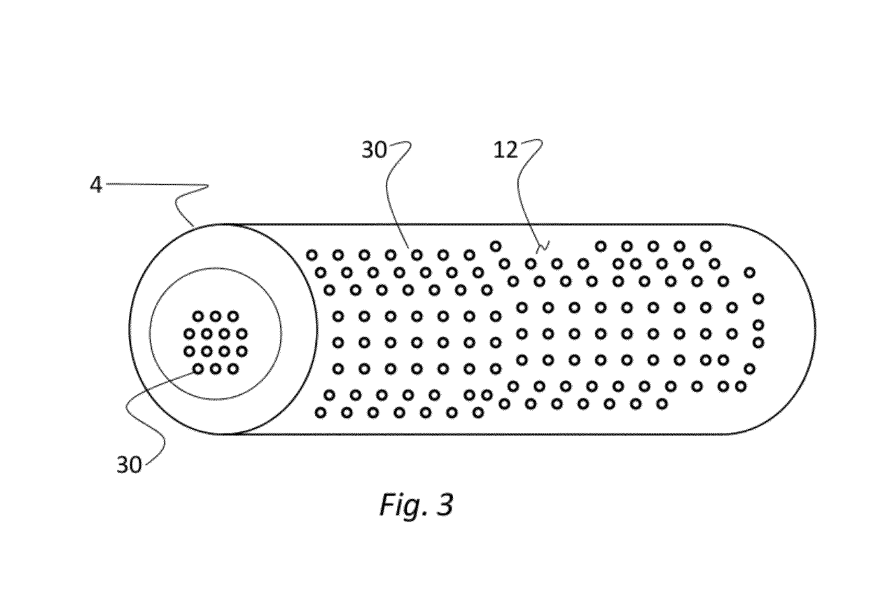

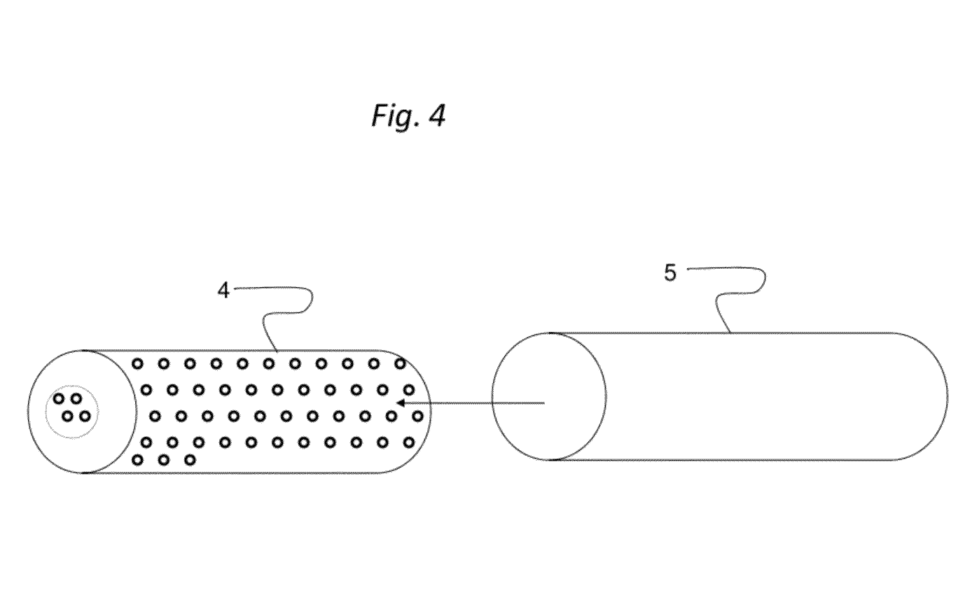

In one example embodiment the ink pumping and control system 2 is responsive to a control value, where the control value sets an operating mode of the ink pumping and control system to variably pump ink to a pump output. The ink reservoir 1 is coupled to an input port of ink pumping and control system 2. A rotary coupling is coupled at a rotary input to the pump output and further includes an output port coupled to the diffusion cylinder 4, which, in turn, is coupled to receive ink pumped through the rotary coupling 3 while rotating. The diffusion cylinder 4 has an inner channel, an outer surface and a plurality of passages surrounding the inner channel, wherein each of the plurality of passages runs though the diffusion cylinder from the inner channel to the outer surface for metering ink at a coarse rate through the plurality of passages as described further herein below with respect to FIG. 3. A permeable membrane 5 is snugly fit over the diffusion cylinder 4 to cover the plurality of passages to receive the coarsely metered ink and, in turn, finely metering ink passing through the permeable membrane as described further herein below with respect to FIG. 4. The printing plate 6 contacts the permeable membrane so as to receive the finely metered ink. A printing medium (bearing against a not-shown substrate or impression cylinder) is in rotary contact with the printing plate to produce a printed output 7. A photo sensor 9 is disposed to sense a portion of the printed output to provide a modified control value.

It will be understood that the apparatus and method described herein applies to both printing plates and printing sleeves. Thus examples and terminology referring to “printing plates” or “plates” are equally applicable to “printing sleeves” and equivalents.

In another example, the flexographic printing system 10 allows for instant control of the amount of ink delivered to the next step of the print process, by using a pressurized ink supply, delivered through a porous diffusing cylinder, and further metered through a permeable application membrane. An operator can control the pressure of the ink supply. Using the sensor, processor and pump controls, the operator can monitor, adjust, and recreate the desired ink volume within the press run, in subsequent press runs, and even across multiple press equipment which are similarly equipped. The design of the flexographic printing system 10 substantially eliminates factors of wear, damage and cleaning difficulty, which prevents variability of print quality.

Referring now to FIG. 3, an example of a diffusion cylinder is schematically shown. The diffusion cylinder 4 includes an inner channel 10 and a machined outer surface 12. In operation, the diffusion cylinder 4 acts as the initial stage of the metering and distribution of the pressurized ink. Ink is forced from the inner channel 10 through machined (e.g. drilled) passages to the machined outer surface 12. The cylinder can be constructed from a variety of materials, including metal, aluminum, steel, plastic, polymers, nylon and equivalents using conventional roll fabrication techniques.

Referring now to FIG. 4, an example of a diffusion cylinder with a permeable membrane tube as employed in a flexographic printing system in accordance with the disclosure herein is schematically shown. The permeable membrane 5 may advantageously be a tube that is snugly fitted over the diffusion cylinder 4 in order to further meter and spread the ink evenly when applied to a printing plate or printing tube. The membrane 5 acts as a second stage of the metering and distribution of the pressurized ink, by allowing the ink from the diffusion cylinder surface to pass through the membrane's porous plastic construction. The permeable membrane 5 may comprise a selectively permeable or semi-permeable membrane that allows printing ink to pass through the membrane. The permeable membrane may be a multilayer composite comprising polymers, fine mesh screens, combinations of materials resistant to ink corrosion and the like. The permeability of the membrane can be adjusted during manufacture in order to impart specific permeability for various types of printing ink (for example, solvent-, water-, and UV-based chemistries), their relative viscosity and rheology characteristics, and the desired ink film to be delivered to the printing plate or printing tube. Although ink-permeable membranes have been used in printing modules, until now it is believed that no one has incorporated an ink-permeable membrane in a flexographic printing system. One example of a printing module incorporating an ink-permeable membrane is disclosed in U.S. Pat. No. 5,555,007, issued Sep. 10, 1996 to Ceschin et al. which is incorporated by reference.

### Porous Tube (Permeable Membrane)

The manufacturers of porous tubes speak in terms of the particle size of the powdered materials they use to produce a sintered porous tube, which is used herein as a medium to distribute the liquid ink from the center of the roll assembly to the outside surface, where it is then applied to the surface of the printing plate. However, in this application, the porosity of that material—not the actual particle size—is of more concern here. The particle size chosen is important because of its indirect relationship to the number and spacing of the subsequent “pores” created by the interference of the powder particles with each other. To achieve the consistent ink distribution for quality printing as required by modern label and package printers using the flexographic printing process, it has been discovered by the inventor herein that powder used in sintering to produce the porous tube must be selected to have a nominal particle size between 1 and 20 microns.

The powder must be placed in the form prior to sintering in a continuous supply without pauses in the filling in order to eliminate striations in the printed image. Such striations are to be avoided and may be caused by microscopic differences in the physical relationship of the powder particles in the areas where the fill would have paused. The powder grade used must have a tighter tolerance than used in other sintering applications in order to produce a more consistent degree of porosity and pore distribution in the finished porous tube surface. Table I shows an example of the grade tolerance for each of the recommended powder grades (˜ indicates nominal particle size in a given batch of powder, as particles cannot be exactly the same):

| | Particle Size Range |
|---|---|
| Powder Size (microns) | (microns) |
| 1 | ~.9 to ~1.1 |
| 2 | ~1.85 to ~2.15 |
| 5 | ~4.8 to ~5.2 |
| 10 | ~9.5 to ~10.5 |
| 20 | ~18.75 to ~21.25 |

### Finished Porous Tube and Shaft Assembly

The requirement for the finally assembled diffusion cylinder with the permeable membrane tube and permanently attached end caps disclosed herein to correctly operate in the printing press is a Total Indicated Runout (TIR) tolerance value of +/−0.001 inch. Anything more than +/−0.001 inch will create unacceptable inconsistency in the printed image. Earlier designs were made as 4 separate parts (center axle, 2 end caps, and the porous tube), all at the 0.001″ tolerance, which were then painstakingly assembled to achieve minimal distortion. However, actual in-press tests proved that this method could not achieve the required 0.001″ tolerance in the finished assembly, since each part could conceivably be off by 0.001″ making the finished assembly off by as much as 0.004″. This issue resulted in the exact degree of inconsistent print quality which was unacceptable in a finished product. Subsequently, while the design of the individual parts has remained basically the same, the assembly method has been changed. The parts are assembled into a first-stage complete unit which is then machined, as by grinding or the like, as a complete unit to the +/−0.001″ TIR tolerance.

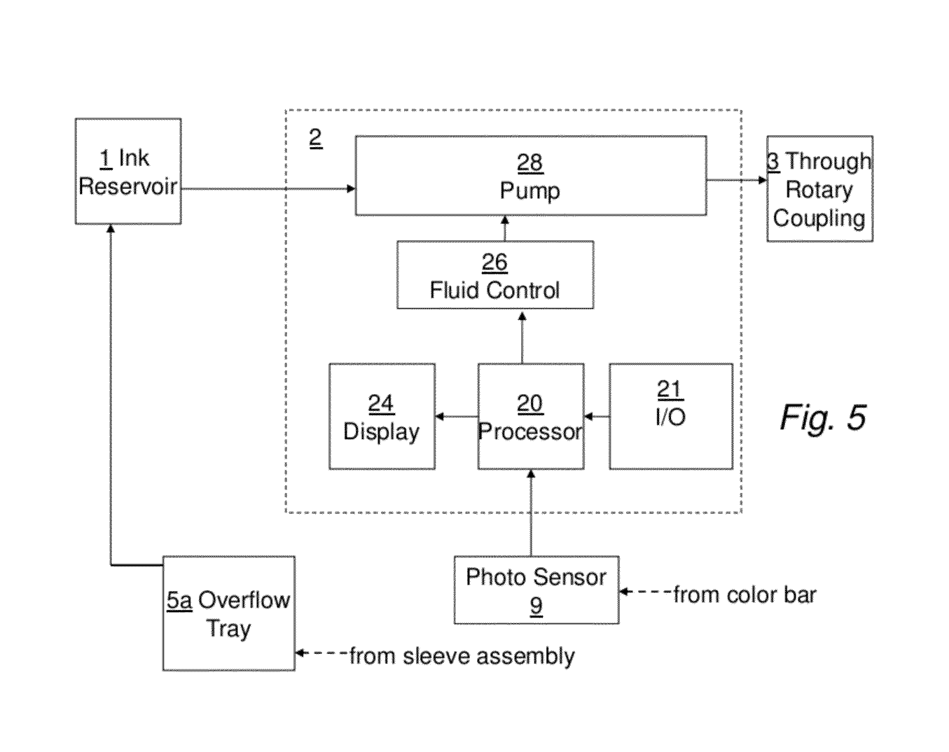

Referring now to FIG. 5 a more detailed example of a pumping and control system as employed in a flexographic printing system in accordance with the disclosure herein is schematically shown. The pumping and control system 2 includes a pump and motor fluid control 26, a pump 28, a processor 20, a display 24, and an input/output system 21. The sensor 9 may advantageously be selected from the group consisting of a photo sensor 9, a spectrodensitometer, a spectrophotometer, a densitometer and a colorimeter. The processor 20 may be connected to the sensor 9 to receive the modified control value. Such sensors are commercially available and are typically used for providing measurements of density, dot gain, trap, print contrast, gray balance, and hue error functions. A densitometer comprises a quality control device to measure the density of printing ink. A colorimeter comprises an instrument for measuring color the way the eye sees color. A spectrodensitometer combines functions of a densitometer with a colorimeter.

For the purposes of this disclosure the processor is understood to encompass a computer processor, a personal computer, a microcontroller, a microprocessor, a field programmable object array (FPOA), a digital signal processor (DSP), an application-specific integrated circuit (ASIC), a field programmable gate array (FPGA), a programmable logic array (PLA), or any other digital processing engine, device or equivalent. The processor may advantageously include a display for monitoring by an operator and an input/output system (e.g. a keyboard and mouse). Other functions may be incorporated into the processor and fluid controls, as for example, ink viscosity controls and mixing systems. In a useful example, an operator may also operate the processor by manually inputting operational modes, control values and the like.

### Rotary Coupling and Bypass Valve

The improved cylinder disclosed herein employs the use of a coaxial rotary coupling as described herein, which allows the use of a secondary control point to aid in making quicker adjustments to applied ink film, therefore affecting printed ink density changes more quickly. This is an important consideration in a live print production setting, as any needed change in ink density must occur rapidly to reduce waste and increase productivity. The coaxial coupling provides the means for quickly dissipating any internal back pressure, allowing any adjustment to the pump speed and flow rate to be seen almost instantly in the printed ink film. Initial results with a single-passage coupling required that any pressure inside the roll simply be allowed to work its way out through the porous tube, which takes too much time, and creates a significant amount of printed waste which has been printed at an incorrect ink density. It has also been found that using a dual-flow coaxial coupling provides improved performance. One useful type of dual-flow coaxial coupling is available from Rotary Systems, Inc. of Minneapolis Minn. 55303 sold as model Series 009 Coaxial Duo Flow Union.

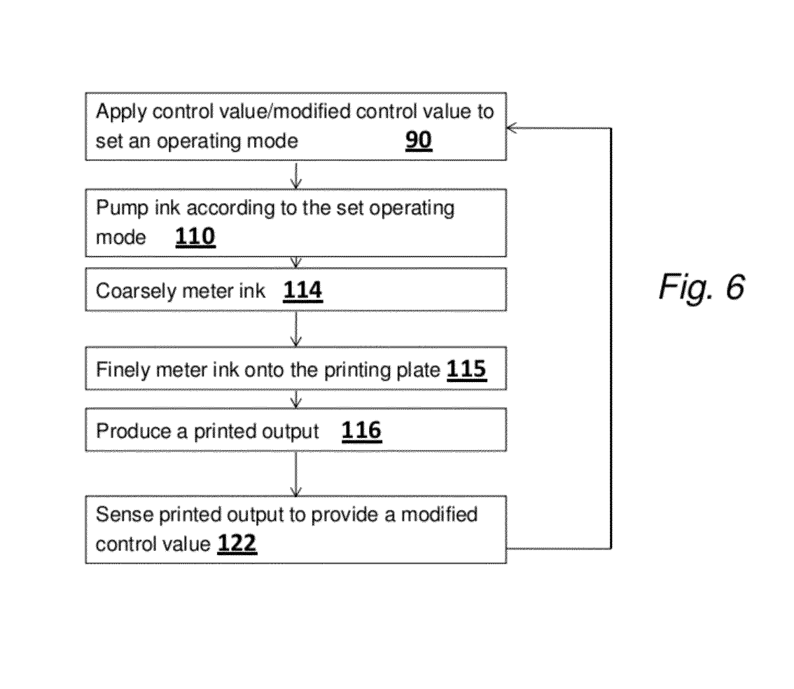

Having described the construction of the contemplated flexographic system, the operation of one example embodiment will now be described to promote further understanding. Referring now to FIG. 6, a flow diagram of a flexographic printing system is schematically shown. Upon initiating the process, a control value is applied 90 to the ink pumping and control system. The ink pumping and control system is responsive to the control value, where the control value sets an operating mode of the ink pumping and control system. Ink is pumped according to the set operating mode 110 through a rotary coupling into a rotating diffusion cylinder including a plurality of passages as described above. Ink is first coarsely metered 114 through the plurality of passages so as to contact the permeable membrane covering the plurality of passages on the diffusion cylinder. Ink passes through the permeable membrane and is finely metered 115 onto the printing plate. The printing plate impresses the printing medium to produce a printed output 116. At least a portion of the printed output is sensed 122 to provide a modified control value, which is, in turn, applied to the ink pumping and control system to vary the pump operation in order to control the amount and consistency of ink being pumped through the downstream components.

In one example embodiment, an operator may read the sensor 9 and manually set the control value on the ink pumping and control system. For other applications requiring continuous feedback and control the sensor 9 may be electronically, digitally or otherwise coupled to transmit the modified control signal to the processor which then automatically applies the modified value to the ink pumping and control system.

For example, the sensor 9 may include a look up table of values with control signals cross-referenced to, for example, a set of densitometer readings. In another example, the control values may be calculated from the sensor readings in a conventional manner within a computer program embedded in the processor. Alternatively the system may be remotely controlled via electromagnetic signals, an Internet Web Site or the like.

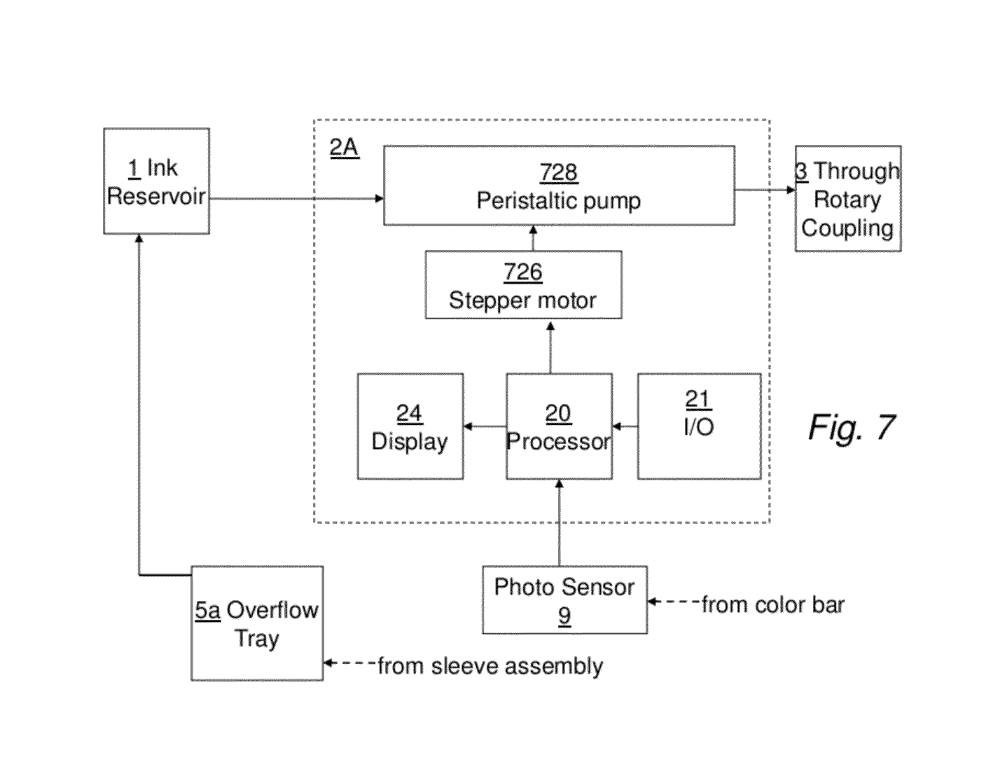

Referring now to FIG. 7, an alternate example of a pumping and control system employing a stepper motor as employed in a flexographic printing system in accordance with the disclosure herein. The components of FIG. 7 are constructed and assembled similarly to the components of FIG. 5 as described above, with the exception that a stepper motor 726 is employed as part of the fluid control 26 and a peristaltic pump 728 is employed as the pump. The operation of the stepper motor and peristaltic pump combination is described in more detail below.

While a centrifugal pump may be used to deliver a constant stream of ink to the roll assembly in press, in some cases it may deliver too much ink, even when “throttled back” using a gate valve to limit flow. A more preferred arrangement employs a peristaltic pump, which provides a positive displacement-type ink supply (there is no gap in the flow—this type of pump is always pushing more ink into the hose, without allowing any ink to backflow), with built-in variability of pump speed. This type of pump performs reasonably well using a typical commercially available model from the industry's leading ink pump vendor. However, such a commercially available pump still delivered too much ink to the roll assembly in press, as the pump would only reduce to a flow rate of around 1 gallon per minute. This rate is acceptable for normal ink pump applications, but the advanced technology disclosed herein has the advantage of using much less ink than a normal flexographic ink station requires.

It was found experimentally that using a peristaltic-type pump with a smaller stepper motor allows for virtually infinite speed control. This is a significant advance over known configurations which employed a much less precise variable speed electric motor. This stepper motor allows operation of the pump at any speed from 1 to 300 RPM, in discrete increments, as for example, 1 RPM increments. Testing has shown that the optimal run speed range for my technology is between 10 and 150 RPM, dependent upon press run speed. Higher run speed requires more ink to be delivered to the porous roll surface, for subsequent delivery to the printing plate. It should also be noted that the peristaltic pump/variable speed motor combination produced minor surging in the ink flow, which showed up as inconsistency in the delivered ink amount. The use of a stepper motor provides a more consistent flow, eliminating surges and the inconsistent ink delivery.

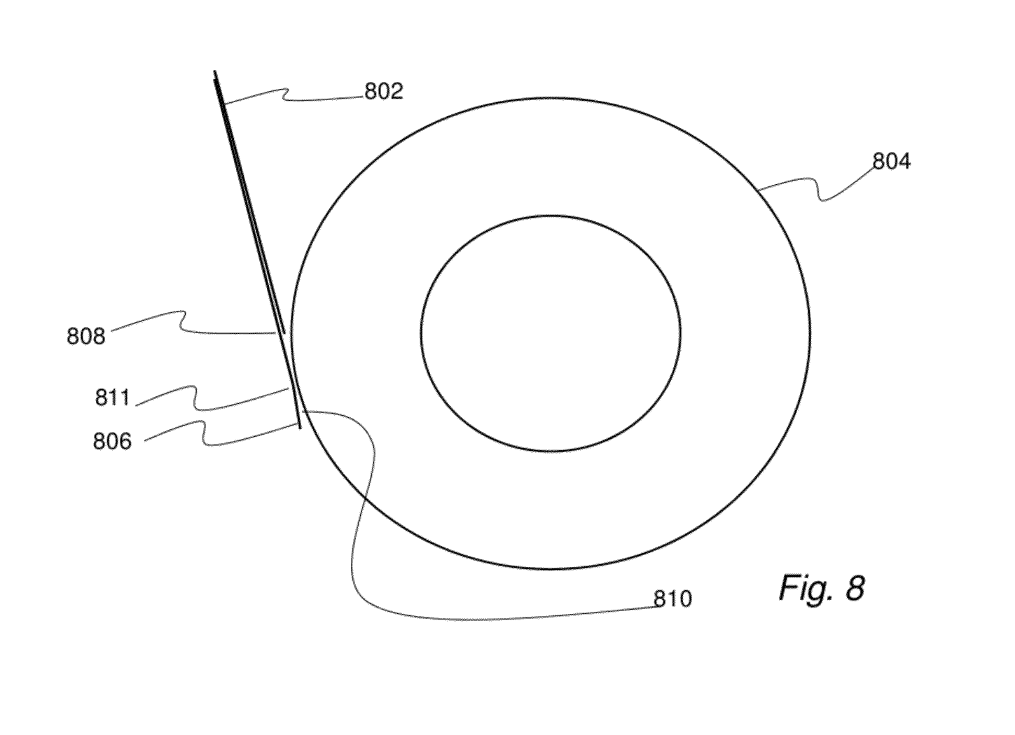

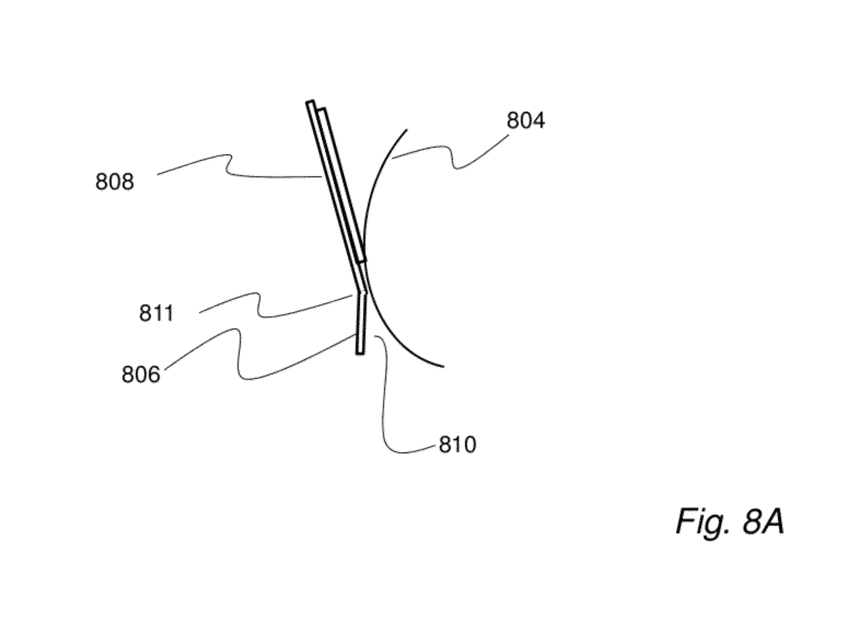

Referring now jointly to FIG. 8 and FIG. 8A, an example of a doctor blade assembly is schematically shown. A dual-blade arrangement includes a doctor blade 802 located alongside a backer blade 808 where the widths of the backer blade and the doctor blade substantially coincide except that a portion of the backer blade extends beyond the elongated edge of the doctor blade at an end proximate the roll 804. In operation, the backer blade 808 has an elongated edge 811 from which deflects to form slightly obliquely angled tip 806 so as to create an ink pocket 810 between the doctor blade 802, the backer blade 808 and the roll 804. The roll 804 preferably comprises a diffusion cylinder with a permeable membrane tube as described herein with reference to FIG. 4, for example. It will be understood that the elongated edge of the doctor blade extends across the useable width of the permeable membrane to clean excess ink from the surface of the permeable membrane.

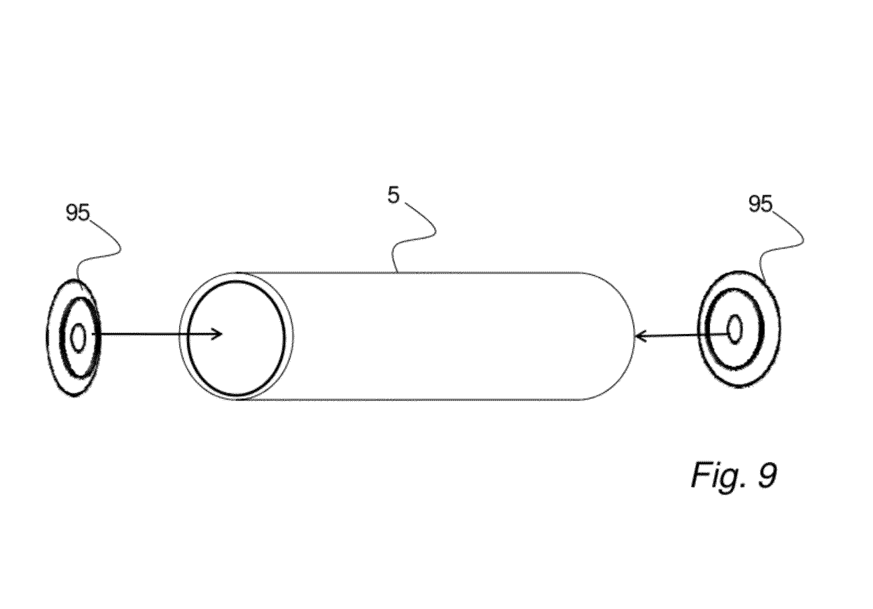

Referring now to FIG. 9 an exploded view of a permeable membrane tube and end caps as employed in a flexographic printing system in accordance with the disclosure herein is schematically shown. A permeable membrane cylinder 5 has ends sized to have right and left end caps 95 tightly press fit into the ends of the permeable membrane cylinder. The end caps 95 include openings for ink to pass through.

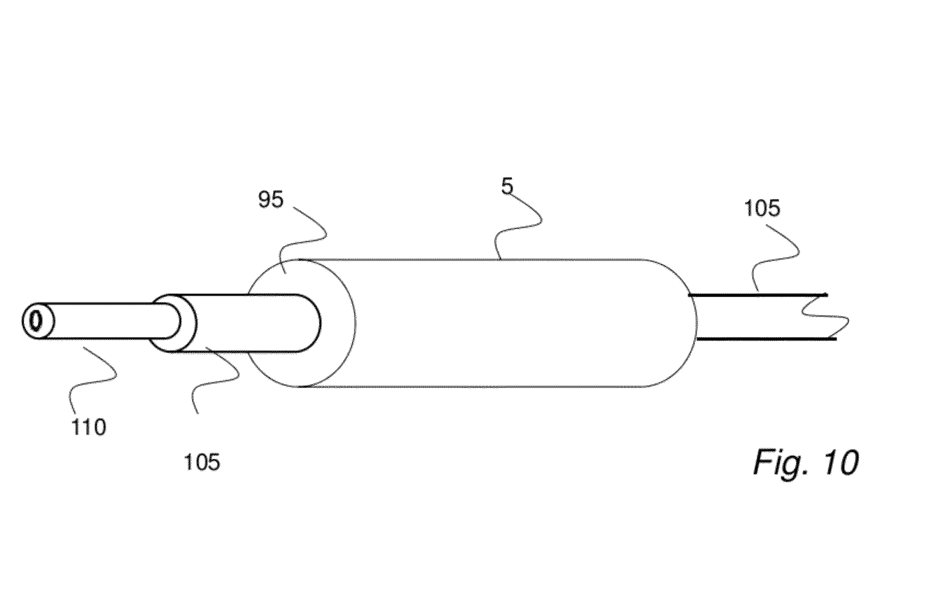

FIG. 10 schematically shows a perspective view of a permeable membrane tube assembly with axle as employed in a flexographic printing system in accordance with the disclosure herein. There shown is the permeable membrane cylinder 5 assembled with end caps 95 tightly press fit into the ends of the permeable membrane cylinder and center axel 105 having a hollow narrower shaft 97 protruding from each end. The end caps are permanently affixed so as to maintain the exacting tolerances needed for consistent inking. The components including permeable membrane tube and end caps must be assembled into a single fixed assembly, then machined to the required tight TIR tolerances as a single unit as discussed herein. Afterwards, the porous material must be etched or otherwise treated to restore the desired level of porosity.

While existing engraved ceramic anilox rolls typically use extremely sharp steel doctor blades to meter off the excess ink from the roll surface, the embodiments herein use similar plastic doctor blades, which are safer to use, and cause much less wear on the roll surface. Testing has proven that a particularly useful blade arrangement for use with the porous roll assembly in press to be a dual-blade arrangement, with a 1.5 inch beveled tip 0.030″ thick polyethylene doctor blade riding against the porous tube surface, and a 2 inch lamella tip 0.030″ thick polyethylene blade used as the backer blade behind the doctor blade, which when installed on the press forces the 2″ backer blade to extend past the actual contact point on the roll and causing it to bend slightly away from the roll surface. The slight bend of less than about 5°, for example, creates the small ink pocket which holds ink against the roll, thereby eliminating inconsistencies in ink coverage on the roll surface.

The nature of the porous tube used in this presently disclosed technology is such that the entire structure of the porous material is filled with a multiplicity of passages, all of which vary in size, shape, position, direction, and consistency. As mentioned previously, testing has shown that the optimal range of porous material grades used to construct a roll for use in printing applications is between 1 and 20 microns. Any printing fluids—inks, coatings, adhesives, and the like—used with this technology must be of sufficiently small particle size as to allow them to pass through the porous roll without being trapped in the smallest pores, which, over time, acts to plug the roll, rendering it useless for further print use until cleaned properly. These printing fluids (inks) must possess a maximum particle size of no more than 25% of the media grade size of the corresponding media used to manufacture the porous roll. Useful examples of media grade size and ink particle size are shown in Table II below.

TABLE II

| Media Grade Roll Particle Size | Maximum Ink Particle Size |
|---|---|
| 1 micron | .25 micron |
| 2 micron | .50 micron |
| 5 micron | 1.25 micron |
| 10 micron | 2.5 micron |
| 20 micron | 5 micron |

### Cleaning Equipment and Methods

The porous roll assembly, given the previously mentioned nature of the multiplicity of passages inside the roll, poses specific challenges to proper cleaning. Testing has shown that the optimal means of cleaning the roll is to submerge the roll in a heated bath of the proper cleaning chemistry for the type of ink which was used, while applying ultrasonic energy to the bath, also while applying reversed pump pressure (back flushing) to pull the dirty cleaning solution from the inside of the roll, effectively pushing any trapped ink particles out from their lodging point, and allowing them to flow back the way they came, discharging from the roll through the former inflow direction.

### Process of Use

Having described the various elements, use of the disclosed printing system will now be discussed in order to aid in understanding the disclosure. In actual use, the porous roll assembly is mated with the coaxial rotary coupling, any needed supporting bearings and drive gears are installed on the center axel, and the complete assembly is placed in the flexographic printing press in place of the traditional engraved ceramic anilox roll. The ink pump is placed near the input end of the center axel, the supply and return hoses or lines are attached, the suction hose or line is placed in the ink supply, and the unit is ready for use. The press operator actuates the pump, which pulls ink from the supply, through the supply hose or line into the rotary coupling, passing further into the internal cavity of the roll assembly, all while the roll is turning within the press as driven by the press itself. The ink passes through the porous tube to the outer roll surface, where it is metered off by the dual-blade doctor blade assembly, creating a starting point on the revolving roll surface from which to measure the desired ink flow rate from that point around to the contact point with the printing plate. The press operator engages the roll to the printing plate, adjusts the press settings as he or she normally would, and once ink is applied from the plate to the substrate, the printed ink density is measured either by manual device, operator vision, or inline automatic density measurement, and the pump flow rate is adjusted to create the desired printed ink density.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment, and devices, and that various modifications, both as to the equipment details and operating procedures, may be accomplished without departing from the true spirit and scope of the present invention.

What is claimed is:

1. A method for flexographic printing comprising:
(a) using a processor to apply a control value to an ink pumping and control system responsive to the control value, where the control value sets an operating mode of the ink pumping and control system, where the ink pumping and control system includes a stepper motor coupled to a peristaltic pump;
(b) supplying ink to an input port of the peristaltic pump;
(c) operating the stepper motor in the set operating mode to drive the peristaltic pump to pump ink into a rotary coupling;
(d) pumping ink through the rotary coupling into a rotating diffusion cylinder, where the diffusion cylinder has affixed end caps, an inner channel, an outer surface and a plurality of passages surrounding the inner channel, wherein each of the plurality of passages runs though the diffusion cylinder from the inner channel to the outer surface and wherein the diffusion cylinder comprises an elongated cylinder constructed from material selected from the group consisting of aluminum, steel, plastic, polymers and nylon;
(e) first metering ink through the plurality of passages so as to contact a permeable membrane covering the diffusion cylinder;
(f) locating a doctor blade against the permeable membrane for cleaning the permeable membrane;
(g) locating a backer blade alongside the doctor blade where the widths of the backer blade and the doctor blade substantially coincide except that a portion of the backer blade extends beyond the elongated edge of the doctor blade at an end proximate the permeable membrane such that in operation, the backer blade has an elongated edge from which deflects to form slightly obliquely angled tip so as to create an ink pocket between the doctor blade, the backer blade and the permeable membrane;
(h) secondly metering ink passing through the permeable membrane onto a printing plate or printing sleeve;
(i) impressing the printing plate or printing sleeve onto a printing medium to produce a printed output;
(j) sensing the printed output to provide a modified control value; and
(k) applying the modified control value to the ink pumping system.

2. The method of claim 1 wherein sensing the printed output comprises sensing a portion of the printed output with a sensor selected from the group consisting of a human operator, a photo sensor, a spectrodensitometer, a spectrophotometer, a densitometer and a colorimeter.

3. The method of claim 1 wherein the rotary coupling is selected from the group consisting of a dual-flow coaxial coupling and a single passage rotary coupling.

4. The method of claim 1 further comprising a preliminary step of machining the rotating diffusion cylinder to a Total Indicated Runout tolerance value of +/−0.001 inch.

5. The method of claim 4 wherein the ink has an ink particle size range consisting of a maximum particle size of no more than 25% of the media grade size of the media used to manufacture the porous roll.

6. The method of claim 1 wherein the control value and modified control value are manually set.

7. The method of claim 1 wherein the permeable membrane comprises a sintered powder and the grade tolerance for the powder grades is selected from the group consisting of the following pairings of powder size and particle size ranges:

| | Particle Size Range |
|---|---|
| Powder Size (microns) | (microns) |
| 1 | ~.9 to ~1.1 |
| 2 | ~1.85 to ~2.15 |
| 5 | ~4.8 to ~5.2 |
| 10 | ~9.5 to ~10.5 |
| 20 | ~18.75 to ~21.25 |

8. The method of claim 1 wherein the ink pumping and control system further comprises a pump and motor fluid control, a processor, a display and an input/output system.

9. The method of claim 1 wherein sensing the printed output comprises sensing characteristics of a color bar.

10. A system for flexographic printing comprising:
(a) an ink pumping and control system responsive to a control value, where the control value sets an operating mode of the ink pumping and control system to variably pump ink to a pump output, where the ink pumping and control system includes a stepper motor coupled to receive operating mode data and coupled to drive a peristaltic pump;
(b) an ink reservoir coupled to an input port of the ink pumping and control system;
(c) a rotary coupling coupled at a rotary input to the pump output and further having an output port;
(d) a diffusion cylinder coupled to receive ink pumped through the rotary coupling while rotating, the diffusion cylinder having affixed end caps, an inner channel, an outer surface and a plurality of passages surrounding the inner channel, wherein each of the plurality of passages runs though the diffusion cylinder from the inner channel to the outer surface for metering ink at a coarse rate through the plurality of passages;
(e) a permeable membrane sleeve fitted over the diffusion cylinder and covering the plurality of passages to receive the coarsely metered ink and finely meter ink passing through the permeable membrane, wherein the assembled diffusion cylinder, end caps and permeable membrane are machined to a Total Indicated Runout tolerance value of +/−0.001 inch;
(f) a printing plate or printing sleeve contacting the permeable membrane so as to receive the finely metered ink;
(g) a printing medium in rotary contact with the printing plate or printing sleeve to produce a printed output;
(h) a sensor disposed to sense a portion of the printed output to provide a modified control value; and
(i) a backer blade alongside a doctor blade, the doctor blade having an elongated edge contacting the permeable membrane, where the widths of the backer blade and the doctor blade substantially coincide except that a portion of the backer blade extends beyond the elongated edge of the doctor blade at an end proximate the permeable membrane such that in operation, the backer blade has an elongated edge from which deflects to form slightly obliquely angled tip so as to create an ink pocket between the doctor blade, the backer blade and the permeable membrane.

11. The system of claim 10 wherein the diffusion cylinder comprises an elongated cylinder constructed from material selected from the group consisting of metal, aluminum, steel, plastic, polymers and nylon.

12. The system of claim 10 wherein the sensor is selected from the group consisting of a human operator, a photo sensor, a spectrodensitometer, a spectrophotometer, a densitometer and a colorimeter.

13. The system of claim 10 wherein the ink has an ink particle size range consisting of a maximum particle size of no more than 25% of the media grade size of the media used to manufacture the porous roll.

14. The system of claim 10 wherein the control value and modified control value are manually set.

15. The system of claim 10 wherein the permeable membrane comprises a sintered powder and the grade tolerance for the powder grades is selected from the group consisting of the following pairings of powder size and particle size ranges:

| | Particle Size Range |
|---|---|
| Powder Size (microns) | (microns) |
| 1 | ~.9 to ~1.1 |
| 2 | ~1.85 to ~2.15 |
| 5 | ~4.8 to ~5.2 |
| 10 | ~9.5 to ~10.5 |
| 20 | ~18.75 to ~21.25 |

16. The system of claim 10 wherein the ink pumping and control system further comprises a pump and motor fluid control, a processor, a display and an input/output system.

17. The system of claim 10 wherein the rotary coupling is selected from the group consisting of a dual-flow coaxial coupling and a single passage rotary coupling.

18. A system for flexographic printing comprising:
(a) an ink pumping and control system responsive to a control value, where the control value sets an operating mode of the ink pumping and control system to variably pump ink to a pump output, where the ink pumping and control system includes a stepper motor coupled to receive operating mode data and coupled to drive a peristaltic pump;
(b) an ink reservoir coupled to an input port of the ink pumping and control system;
(c) a dual-flow rotary coupling coupled at a rotary input to the pump output and further having an output port;
(d) a diffusion cylinder coupled to receive ink pumped through the dual-flow rotary coupling while rotating, the diffusion cylinder having affixed end caps, an inner channel, an outer surface and a plurality of passages surrounding the inner channel, wherein each of the plurality of passages runs though the diffusion cylinder from the inner channel to the outer surface for metering ink at a coarse rate through the plurality of passages;
(e) a permeable membrane sleeve fitted over the diffusion cylinder and covering the plurality of passages to receive the coarsely metered ink and finely meter ink passing through the permeable membrane, wherein the assembled diffusion cylinder, end caps and permeable membrane are machined as a single assembly to a Total Indicated Runout tolerance value of +/−0.001 inch;
(f) a printing plate or printing sleeve contacting the permeable membrane so as to receive the finely metered ink;
(g) a backer blade positioned alongside a doctor blade, the doctor blade having an elongated edge contacting the permeable membrane, where the widths of the backer blade and the doctor blade substantially coincide except that a portion of the backer blade extends beyond the elongated edge of the doctor blade at an end proximate the permeable membrane such that in operation, the backer blade has an elongated edge from which deflects to form slightly obliquely angled tip so as to create an ink pocket between the doctor blade, the backer blade and the permeable membrane;
(h) a printing medium in rotary contact with the printing plate or printing sleeve to produce a printed output; and
(i) a sensor disposed to sense a portion of the printed output to provide a modified control value.

19. The system of claim 16 wherein the diffusion cylinder comprises an elongated cylinder constructed from material selected from the group consisting of metal, aluminum, steel, plastic, polymers and nylon.

20. The system of claim 16 wherein the means for sensing the printed output comprises sensing a portion of the printed output with a sensor selected from the group consisting of a human operator, a photo sensor, a spectrodensitometer, a spectrophotometer, a densitometer and a colorimeter.

21. The system of claim 16 wherein the means for sensing the printed output comprises means for sensing characteristics of a color bar.

22. The system of claim 16 wherein the ink has an ink particle size range consisting of a maximum particle size of no more than 25% of the media grade size of the media used to manufacture the porous roll.

23. The system of claim 16 wherein the control value and modified control value are manually set.

24. The system of claim 16 wherein the permeable membrane comprises a sintered powder and the grade tolerance for the powder grades is selected from the group consisting of the following pairings of powder size and particle size ranges:

| | Particle Size Range |
|---|---|
| Powder Size (microns) | (microns) |
| 1 | ~.9 to ~1.1 |
| 2 | ~1.85 to ~2.15 |
| 5 | ~4.8 to ~5.2 |
| 10 | ~9.5 to ~10.5 |
| 20 | ~18.75 to ~21.25 |
